(19) United States
(12) Patent Application Publication
(10) Pub. No.: US 2026/0348116 A1
(43) Pub. Date: Nov. 5, 2026

(54) METHOD FOR LIFTING AND FALLING STOPLOG GATE FOR LAYERED WATER INTAKING AND ECOLOGICAL DISPATCHING OF HYDROPOWER STATION

(71) Applicant: CHINA YANGTZE POWER CO., LTD., Wuhan, Hubei (CN)

(72) Inventors: Tangwei BAO, Wuhan, Hubei (CN); Wanli DONG, Wuhan, Hubei (CN); Wenzhong LIU, Wuhan, Hubei (CN); Zhaoli ZHANG, Wuhan, Hubei (CN); Wenliang LIU, Wuhan, Hubei (CN); Dexin LIU, Wuhan, Hubei (CN); Fei DAI, Wuhan, Hubei (CN); Hongyi ZHANG, Wuhan, Hubei (CN); Dawen TAN, Wuhan, Hubei (CN); Chunyao HOU, Wuhan, Hubei (CN); Chunqi MENG, Wuhan, Hubei (CN)

(73) Assignee: CHINA YANGTZE POWER CO., LTD., Wuhan, Hubei (CN)

(21) Appl. No.: 19/101,971

(22) PCT Filed: Apr. 28, 2023
(86) PCT No.: PCT/CN2023/091633

§ 371 Date: Feb. 7, 2025

(30) Foreign Application Priority Data
Aug. 15, 2022 (CN) 202210976663.1

(51) Int. Cl. E02B 9/02

(52) U.S. Cl. CPC E02B 9/022

(57) ABSTRACT

Provided is a method for lifting and falling a stoplog gate for layered water intaking and ecological dispatching of a hydropower station. Under a condition that original main equipment and facilities remain unchanged, an intelligent terminal of Internet of Things for wireless communication transmission is added to be connected to an on-site gantry crane, the intelligent terminal is configured to collect various analog signals and switching signals on site in real time and to carry out data interaction with a cloud platform through a base station, thus replacing a commonly used wired transmission mode at present.

### FIELD

The present disclosure belongs to the technical field of water intaking dispatching of hydropower stations, and in particular to a method for lifting and falling a stoplog gate for layered water intaking and ecological dispatching of a hydropower station.

### BACKGROUND

In the hydropower generation system, for the power station with a high-head intake and power generation structure, the water temperature in the lower reaches will be lower due to a high water head at the water intake of the hydropower station, which is not conducive to the reproduction of fish and other organisms in the river and does not meet the requirements of water environmental protection. Therefore, a special water retaining stoplog gate is arranged in layers at the water intake part of the hydropower station. The stoplog gate is put into use by multiple independent small stoplog gates in a connection and superposition combination manner, which is used to control the temperature of the water discharged from the reservoir area at the water intake, making the downstream water temperature meet the reproduction of fish and other organisms.

To control the temperature of discharged water accurately, multiple layers of stoplog gates are generally used to control the water temperature as needed. At present, the water intake of Xiluodu Power Station is equipped with four layers of stoplog gates, and the water intake of each unit is provided with five gate slots, and there are 90 stoplog gates for 18 units (4 stoplog gates for each set), and there are 360 stoplog gates (90 sets×4=360 ). Every time ecological dispatching is carried out, it is necessary to open and close the stoplog gate layer by layer according to the downstream water temperature demand, and the stoplog gate is generally operated by a gantry crane. However, as a gantry crane is generally used to open and close the stoplog gate, and its own lifting height and lifting weight are limited, it is impossible to assemble the required stoplog gate height at one time and then put the gates down together, it is necessary to fall the stoplog gates layer by layer. At present, it takes 13.5 days to fall 90 stoplog gates at the first layer, and 22.5 days to fall the stoplog gates at the second, third and fourth layers, respectively, which is too time-consuming.

Meanwhile, such stoplog gates are usually placed in the gate storage slot when not in use, the gantry crane is required to constantly change the stoplog gates between the gate storage slot and the working gate slot, which leads to the complicated opening and closing process of such stoplog gates. The gantry crane is required to continuously make the gantry system travel left and right and a trolley system travel back and forth to hoist the stoplog gate, and the stoplog gates in the gate storage slot are put into the working gate slot of the stoplog gate according to a required water retaining height to discharge required water temperature into the downstream rivers, thus satisfying the reproduction of fish and other creatures. At present, all these operations need to be done manually, such as manually driving the gantry crane to the corresponding gate storage slot, manually opening the cover plate of the gate storage slot, manually hoisting the required stoplog gates and manually placing the stoplog gates placing in the working gate slot, and meanwhile, the connection and disassembly of the stoplog gates one by one require manual operation at the orifice for a long time, which makes such operation methods be slow and labor-intensive, and inconsistent with the requirements of the existing intelligent operation of equipment. Therefore, a method for automatically opening and closing the stoplog gate for layered water intaking and ecologic dispatching of the hydropower station is a technical problem to be solved urgently by technicians in this field.

### SUMMARY

The technical problem to be solved by the present disclosure is to provide a method for lifting and falling a stoplog gate for layered water intaking and ecological dispatching of a hydropower station. Under a condition that original main equipment and facilities remain unchanged, an intelligent terminal of Internet of Things for wireless communication transmission is added to be connected to an on-site gantry crane, the intelligent terminal is configured to collect various analog signals and switching signals on site in real time and to carry out data interaction with a cloud platform through a base station, thus replacing a commonly used wired transmission mode at present. For main equipment, the accurate positioning of a gantry traveling mechanism and a trolley traveling mechanism of the gantry crane is added, and automatic identification and determination of the gantry crane and the stoplog gate by a control system can be achieved through accurate positioning of the stoplog gate by a hydraulic grab beam and automatic pin threading and withdrawing in place, an automatic action-return function of a swing beam locking device as required, a function of automatically opening and closing a cover plate of a gate storage slot and a layered counting and identification function of a system for the stoplog gate, thus implementing remote operation of the stoplog gate, achieving automatic operation of layered water intaking and ecological dispatching, improving working efficiency, reducing long-term work of operating personnel at an orifice, reducing an operation risk, and improving the safety performance.

To solve the aforementioned technical problems, the technical solution adopted by the present invention is: a method for lifting and falling a stoplog gate for layered water intaking and ecological dispatching of a hydropower station, comprising the following steps:
S1: network establishment: installing an intelligent terminal of Internet of things, a 5G base station and a cloud platform on on-site equipment to achieve man-machine communication between a background and the on-site equipment and ensure safe operation of an open-close gate;
S2: gantry crane positioning: additionally adding a positioning and identification element on each of a gantry mechanism and a trolley mechanism of the gantry crane, and physically marking orifices of a working gate slot of the stoplog gate and a gate storage slot to ensure that the gantry crane is able to accurately travel to an orifice position of a designated gate slot, and then stopping and controlling a hydraulic grab beam to open and close the stoplog gate;
S3: grab beam positioning: positioning a height of the hydraulic grab beam through a height encoder on the gantry crane, and comparing the height with a preset parameter value of the system to ensure that the height of the hydraulic grab beam is controlled, when the hydraulic grab beam approaches the stoplog gate, guiding the hydraulic grab beam to enter a lifting lug of the stoplog gate through a positioning guide sleeve, and enabling a pin shaft of a pin threading system of the hydraulic grab beam to pass through the lifting lug of the stoplog gate safely to ensure that the hydraulic grab beam is effectively connected to the stoplog gate;
S4: automatic cover plate opening: driving cover plates on an orifice protection device of the gate storage slot to open through two positioning cylinders on the hydraulic grab beam;
S5: layered dispatching: transferring, by hoisting equipment, the stoplog gate to a position above a stoplog gate orifice, and releasing the stoplog gate, wherein a swing locking mechanism carries out automatic action and return during upward and downward movement of the gate storage slot to close or open the stoplog gate to achieve layered water intaking from a hydropower station; and
S6: automatic cover plate closing: controlling and hoisting, by the hoisting equipment, the stoplog gate to a position above the gate storage slot, and automatically closing the cover plates on the protection device when the stoplog gate is released into the gate storage slot.

The protection device comprises claw-type mechanisms connected to two ends of two cover plates, a plurality of counterweight arms and folding arms are connected to one side of each cover plate, an unlocking mechanism is connected to the claw-type mechanism and in fit with a locking mechanism, a contact roller is fixedly connected to a ribbed slab of a side surface of the stoplog gate, and the cover plate is hinged with an edge of the gate storage slot; the locking mechanism is located at one side of the gate storage slot and in fit and locking with the claw-type mechanism; the unlocking mechanism is configured to unlock the locking mechanism and pull the claw-type mechanism to move upwards to close the cover plate; or after the cover plate is closed, a downward pressure of the folding arm is applied, and the cover plate is opened with the cooperation of the counterweight arm and the folding arm.

Each cover plate is a flat plate with a grid structure, and a circular through hole is formed in an open-close port of each of the two cover plates to fit with a bump on the folding arm; the claw-type mechanism comprises piston rods hinged to both sides of an upper end of a sliding rod, the other ends of the piston rods are movably connected to the cover plates; the sliding rod is in sliding fit with a slide rail, and the slide rail is fixed to an inner wall of the gate storage slot; the locking mechanism (106) comprises a lock pin which is in elastic and sliding fit with an inner side of a sleeve, the lock pin extends out of the sleeve and is in fit with a locking hole in the sliding rod, and an inclined plane is arranged at a front end of the lock pin to be in fit with the unlocking mechanism (105); the unlocking mechanism (105) comprises a hook plate connected to a lower end of an unlocking rod, and a rolling shaft passing through the hook plate; a bevel block connected to an upper end of the unlocking rod is located on an upper part of a support plate on the side surface of the sliding rod, and the bevel block is in sliding contact with the inclined plane at the front end of the lock pin; a spring at a lower part of the support plate is sleeved outside the unlocking rod and abutted against a retaining ring on the support plate and the unlocking rod; and the hook plate is connected to a pin shaft at a lower end of the sliding rod, and the rolling shaft is in rolling contact with the slide rail.

A gear is connected to an end head of the counterweight arm and an end head of the folding arm, respectively, the gear is meshed with a gear at an end head of a slotted plate and located in a hinged seat of the cover plate, and the slotted plate is fixedly connected to the cover plate; one end, away from the gear, of the counterweight arm is provided with a counterweight block, a bending structure is arranged at a middle part of the folding arm, and a bump is arranged on an upper side surface of one end of the folding arm; and when two symmetrical folding arms on the two cover plates are in a horizontal state, the two bumps are located in the circular through holes in the cover plates in a horizontal state.

The swing locking mechanism comprises a rotating shaft in fit with upper ends of support arms of a fixed seat, swing arms are connected to shaft heads at two ends of the rotating shaft and inclined to one side; a locking beam is located between the two support arms and connected to the rotating shaft; a stress block is located at a lower part of the swing arm at one side of the support arm; the locking beam is of a hollow structure, and a heavy hammer is arranged in a compartment at a lower end thereof; the fixed seat of the swing locking mechanism is installed on a side surface of the stoplog gate orifice, and the swing arm and the stress block are close to the stoplog gate orifice.

In S4, automatic cover plate opening comprises the following steps:
S4-1: starting: controlling, by the hoisting equipment, the hydraulic grab beam to move to an upper part of the orifice of the gate storage slot, and making the positioning cylinders on the hydraulic grab beam move downwards;
S4-2: jacking: enabling the positioning cylinders to move downwards to abut against the bumps in the circular through holes in the two cover plates, and driving the folding arms to rotate downward around the hinged seats;
S4-3: cover plate opening: driving the cover plates to overturn upwards during downward rotation of the folding arms, and overturning the counterweight arms downwards at the same time, and driving the two cover plates to form a certain opening therebetween under the action of dead weights of the counterweight arms and the folding arms, wherein the piston rods extend synchronously in the step;
S4-4: unlocking: controlling, by the hoisting equipment, the hydraulic grab beam to ascend and move to an upper part of the stoplog gate, connecting a pin threading device on the hydraulic grab beam to the stoplog gate; controlling, by the hoisting equipment, the hydraulic grab beam to drive the stoplog gate to move to a position between the two cover plates and descend from an opening between the two cover plates, wherein during the descending of the stoplog gate, the contact roller on the side surface of the stoplog gate gradually makes contact with the hook plate of the unlocking plate, the bevel block at the upper end of the unlocking rod is driven to be in sliding contact with the inclined plane at the end head of the lock pin of the locking mechanism, making the lock pin gradually withdrawn from the locking hole in the side surface of the sliding rod; and
S4-5: protection forming: under a condition that the sliding rod is released, enabling the counterweight arms and the folding arms to further rotate downwards under the action of the dead weight, wherein the cover plates are driven to be opened completely to jointly form protection together with the extended piston rods, which is enclosed around the orifice of the gate storage slot.

In S5, a close gate and an open gate in layered dispatching and water intaking comprise accurate positioning of a gantry traveling mechanism and a trolley traveling mechanism of the gantry crane to complete accurate positioning of the stoplog gate by a hydraulic grab beam and automatic pin threading and withdrawing in place, an automatic action-return function of a swing beam locking device as required, and a function of automatically opening and closing a cover plate of a gate storage slot and a layered counting and identification function of a system for the stoplog gate, thus achieving automatic identification and determination of the gantry crane and the stoplog gate by the control system, and achieving automatic operation of layered water intaking and ecological dispatching.

In S6, automatic cover plate closing comprises the following steps:
S6-1: hoisting and transferring: hoisting, by the hoisting equipment, the hydraulic grab beam, connecting the hydraulic grab beam to a pin threading hole in an upper side of a gate through a hydraulic pin threading device, and then lifting and transferring, by the hoisting equipment, the gate to the upper part of the orifice of the gate storage slot;
S6-2: descending and unlocking: driving, by the hoisting equipment, the hydraulic grab beam to descend, wherein the stoplog gate enters the orifice of the gate storage slot with the descending of the hydraulic grab beam, the contact roller gradually makes contact with the swing arm to drive the unlocking rods to move upward, and the bevel block at the front end of the unlocking rod is in sliding fit with the inclined plane at the end head of the lock pin, making the lock pin withdrawn from the locking hole in the sliding rod;
S6-3: initial closing: enabling the stoplog gate to continue to descend downwards, further pushing the swing arm to make the rolling shaft on the hook plate gradually approach and make rolling contact with the slide rail, driving the unlocking rod to pull the sliding rod to move downwards, wherein the sliding rod gradually drives the piston rod to fold and pull the cover plate to close gradually during the downward movement, making two cover plates form a certain opening, and in the step, in the process of gradually closing and overturning the cover plate, the folding arm and the counterweight arm rotate around the hinged seat, respectively;
S6-4: gate release: after the bottom of the stoplog gate is in contact with the bottom of the gate storage slot, enabling the pin threading device of the hydraulic grab beam to withdraw from the pin threading hole in the upper side of the gate, and lifting, by the hoisting equipment, the hydraulic grab beam to ascend gradually; and
S6-5: complete closing: after the hydraulic grab beam completely withdraws from the upper parts of the two cover plates, enabling the cover plates to be completely closed by means of own gravity and the dead weights of the counterweight arms and the folding arms, meanwhile, enabling the end head of the lower end of the sliding rod to abut against with an end plate at a lower end of the slide rail for limiting, retracting the piston rods of the claw-type mechanisms to support both ends of the cover plate.

The action of the swing locking mechanism comprises the following steps:
controlling, by the hydraulic grab beam, the stoplog gate to move downwards, wherein in the process that the stoplog gate falls into a gate slot of the stoplog gate, the contact roller gradually makes rolling contact with the upper side surface of the swing arm to drive the swing arm to drive the rotating shaft to rotate, and the rotating shaft drives the locking beam to deflect towards an inner side of a support hole in the stoplog gate, making an end head at an upper end of the locking beam enter the support hole in the stoplog gate; limiting downward movement of the locking beam by the stress block, thus preventing the stoplog gate from moving downwards and making the stoplog gate in a locking position, wherein the contact roller is located at a lower part of the swing arm at the moment.

The return of the swing locking mechanism comprises the following steps: controlling, by the hydraulic grab beam, the stoplog gate to move upwards, wherein the locking beam deflects under the action of the heavy hammer to gradually withdraw from the support hole in the stoplog gate in a vertical state; and
if the locking beam is withdrawn from the support hole in the stoplog gate during upward movement of the stoplog gate, and the contact roller is still at the lower part of the swing arm, regarding that the stoplog gate is in an unconstrained state, continuing to release the stoplog gate to move downwards, and controlling, by the hydraulic grab beam, a descending height of the stoplog gate.

The main beneficial effects of the present disclosure are as follows: one piece of gantry hoisting equipment is remotely and automatically controlled to alternately operate the opening and closing of multiple stoplog gates, which improves the labor efficiency.

The application of a method for remotely and automatically controlling one piece of gantry hoisting equipment to alternately operate the opening and closing of multiple stoplog gates can achieve an unmanned operation of opening and closing stoplog gates for layered water intaking and ecological dispatching at a water intake of the hydropower station, which can reduce the outdoor working time of the operating staff.

The positioning cylinder on the hydraulic grab beam is configured to open the cover plate at the orifice of the gate storage slot to a certain extent, and then the cover plate is opened by means of the dead weight of the cover plate, the counterweight arm and the folding arm to form protection. In the process of lowering the stoplog gate into the gate storage slot, the unlocking mechanism is driven by the stoplog gate to unlock to automatically close the cover plate without the intervention of personnel, and the safety performance and efficiency are improved.

The swing locking mechanism is arranged at the stoplog gate orifice, and the locking beam of the swing locking mechanism is in fit with the support hole in the side surface of the stoplog gate to achieve action and return, which is beneficial to accurately controlling the operation of the stoplog gate, improving the efficiency of layered water intaking, and improving the operation

### BRIEF DESCRIPTION OF THE DRAWINGS

The present disclosure is further described below with reference to the accompanying drawings and embodiments:

FIG. 1 is a diagram of a use state of the present disclosure;

FIG. 2 is sectional diagram of FIG. 1;

FIG. 3 is a side view of FIG. 1;

FIG. 4 is a schematic structural diagram of an orifice protection device of a gate storage slot according to the present disclosure;

FIG. 5 is a diagram showing an operation state of a stoplog gate at a stoplog gate orifice according to the present disclosure;

FIG. 6 is a front view of FIG. 5;

FIG. 7 is a schematic structural diagram of a swing locking mechanism according to the present disclosure;

FIG. 8 is an enlarged view of A in FIG. 5;

FIG. 9 is a state diagram of an orifice protection device of a gate storage slot according to the present disclosure after being closed;

FIG. 10 is a state diagram of an orifice protection device of a gate storage slot according to the present disclosure after being opened;

FIG. 11 is a state diagram showing cooperation among a sliding rod, a locking mechanism and an unlocking mechanism according to the present disclosure.

In the drawings: 0—concrete foundation at water intake of hydropower station; 1—trash rack and trash rack orifice; 2—stoplog gate and stoplog gate orifice; 3—swing locking mechanism; 4—first gate storage slot and cover plate; 5—second gate storage slot and cover plate; 6—third gate storage slot and cover plate; 7—hoisting equipment; 8—hydraulic grab beam; 9—access gate of unit; 10—accident rapid gate of unit; 11—vent hole; 101—cover plate; 102—claw-type mechanism; 103—counterweight arm; 104—folding arm; 105—unlocking mechanism; 106—locking mechanism; 107—contact roller; 201—support arm; 202—swing arm; 203—locking beam; 204—stress block; 205—heavy hammer.

### DETAILED DESCRIPTION

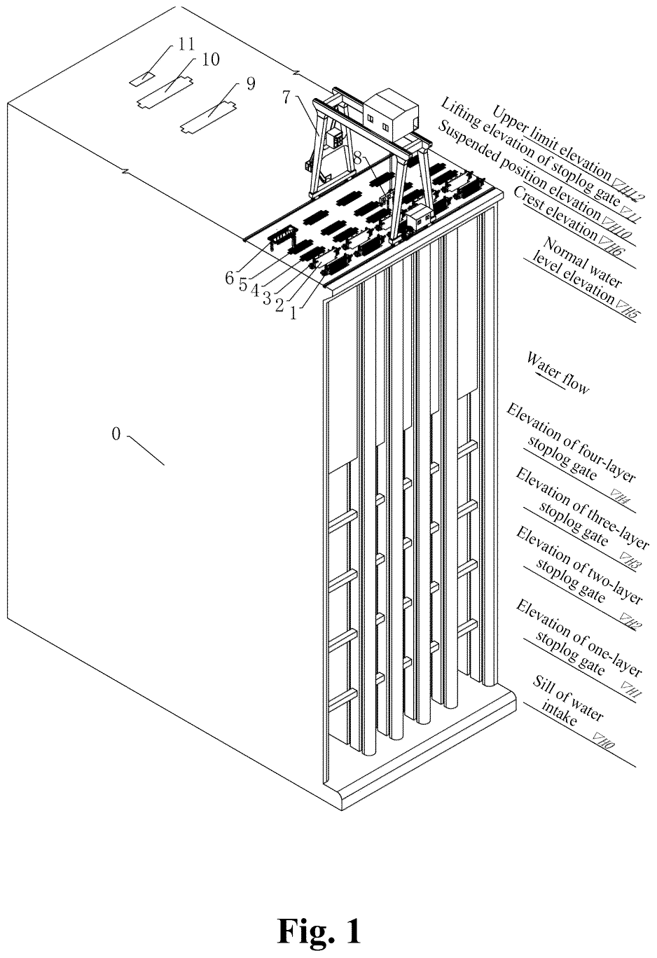

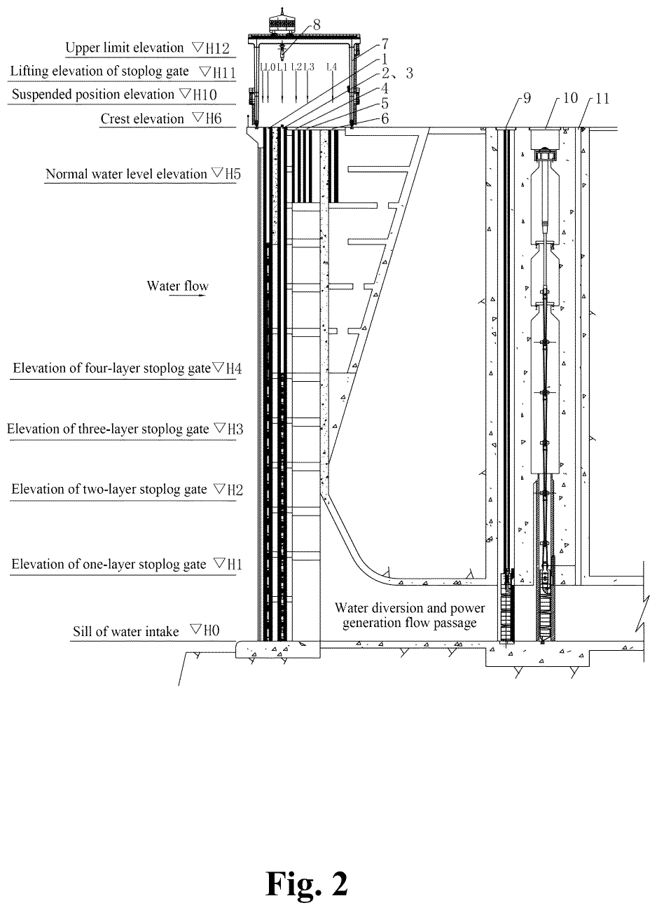

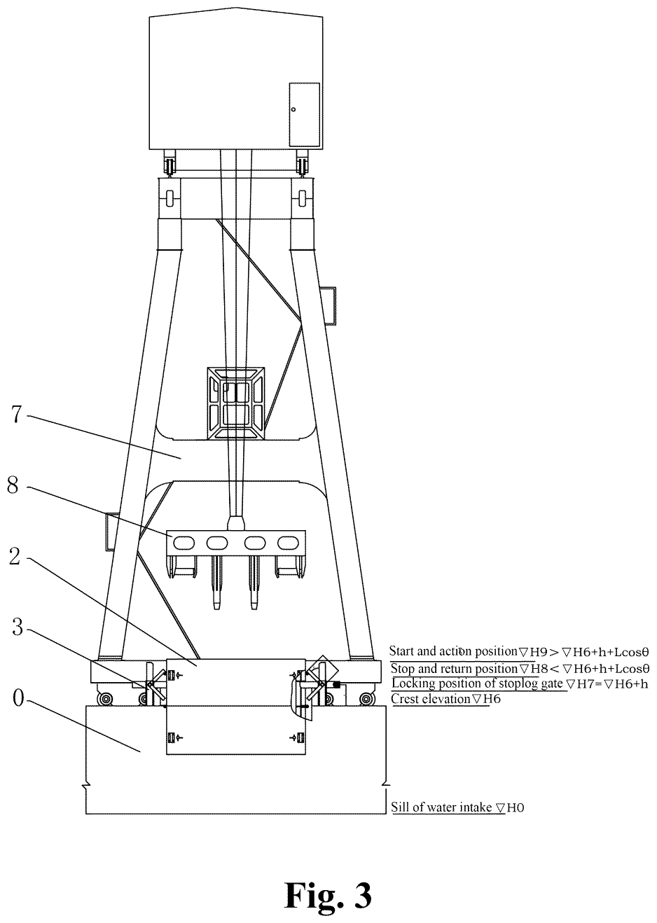

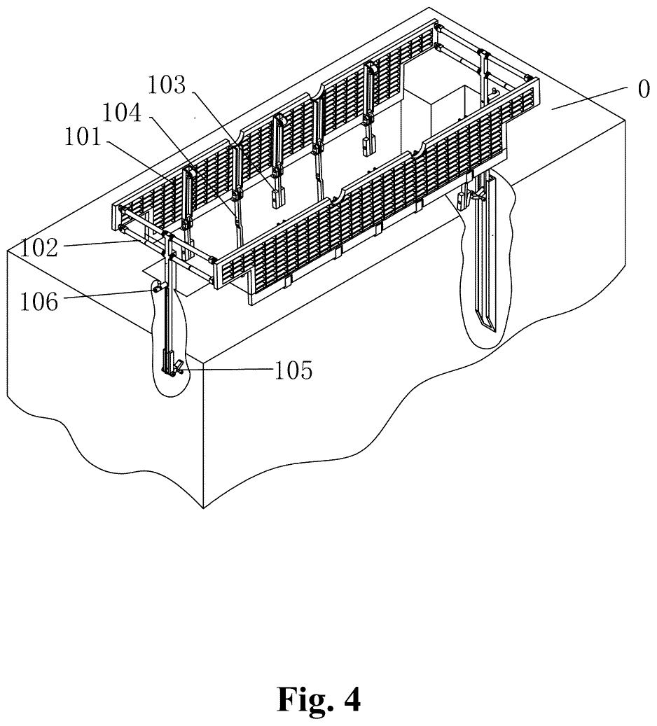

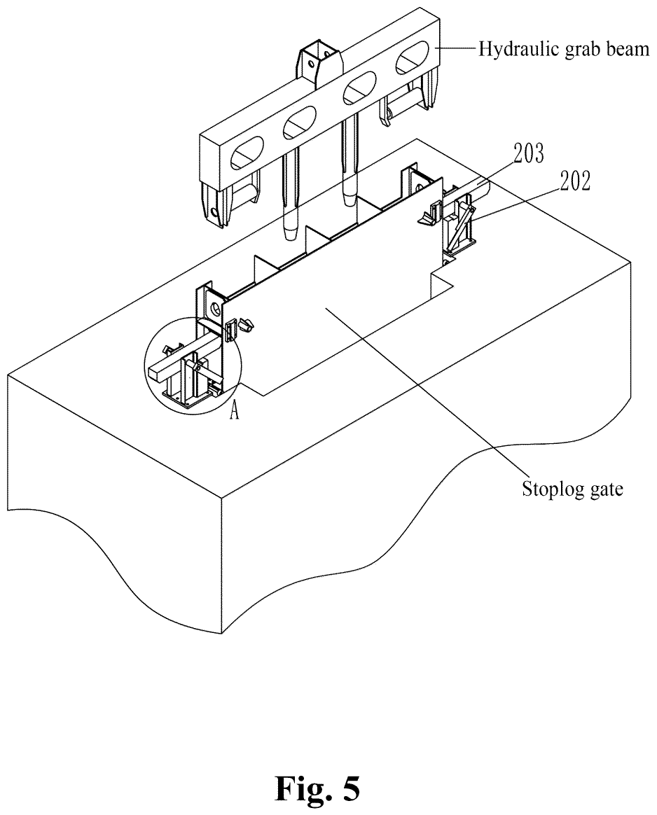

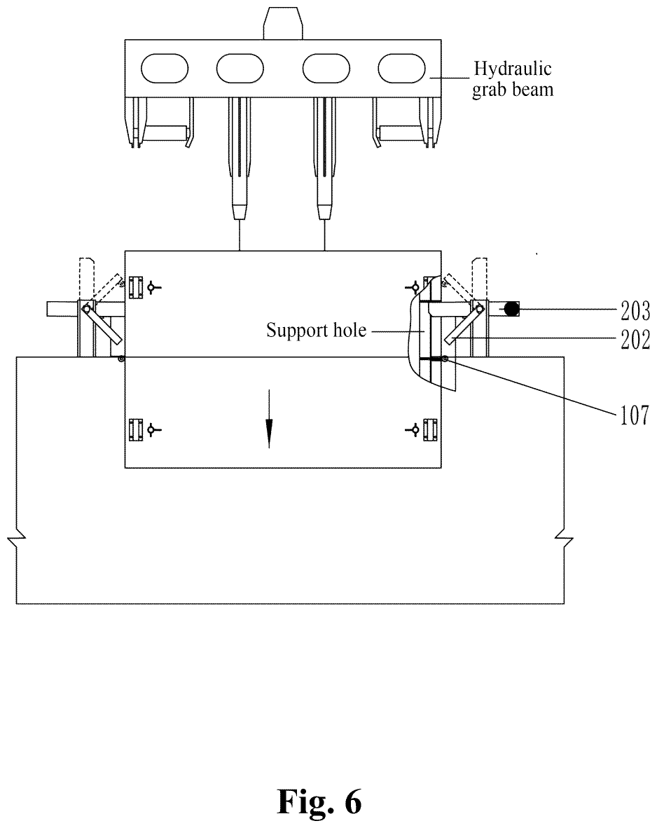

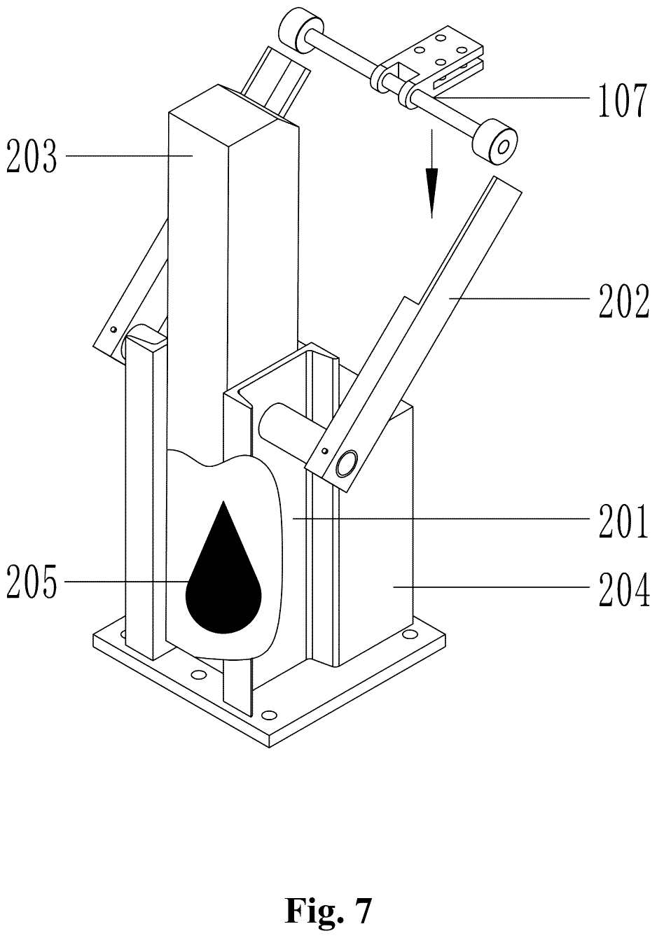

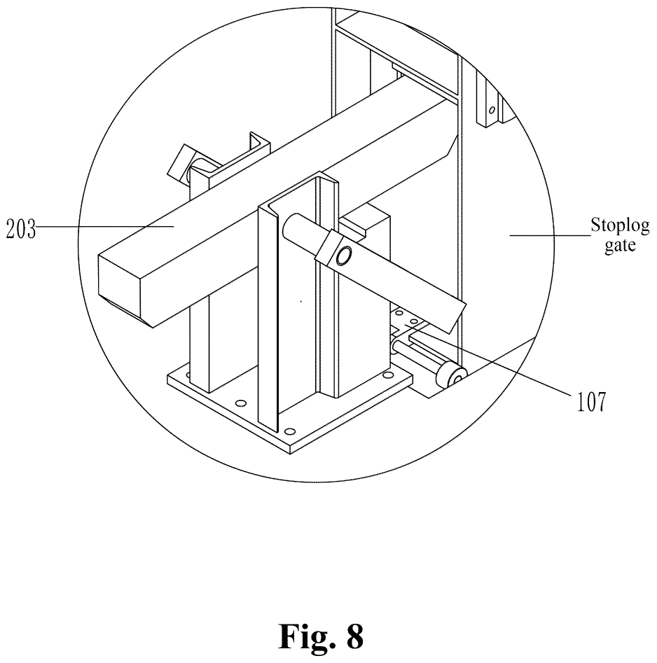

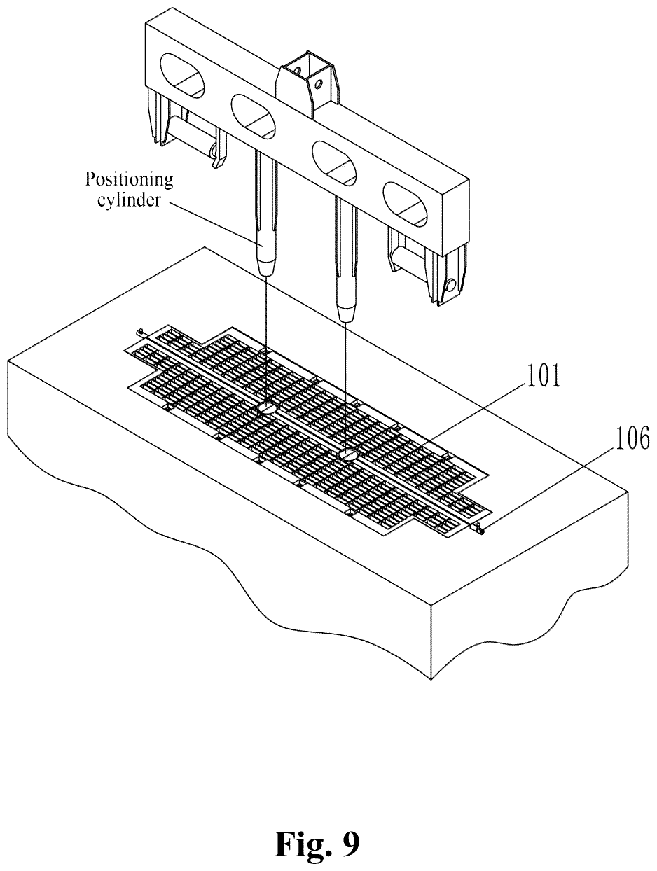

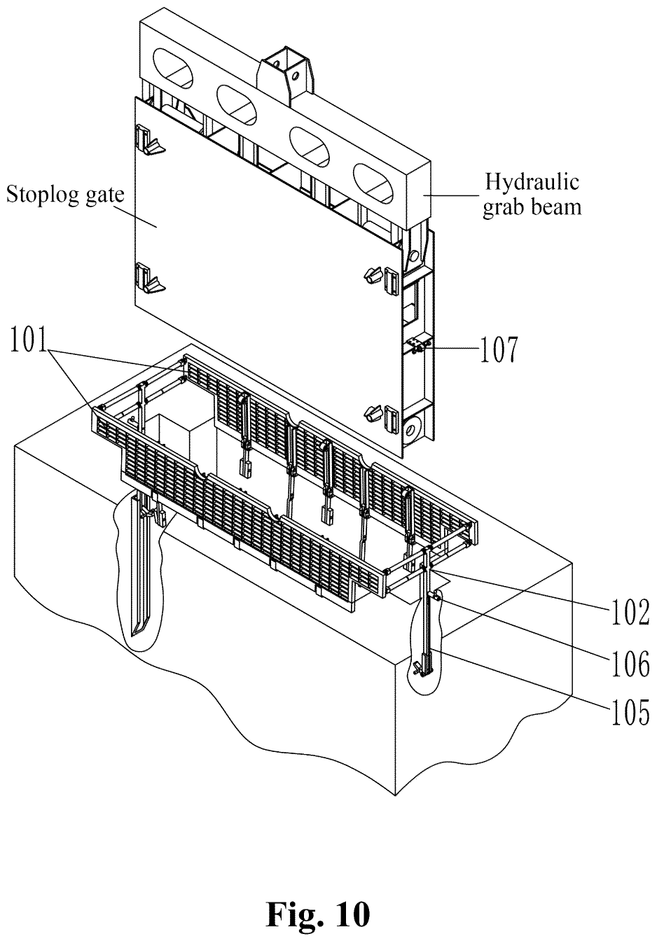

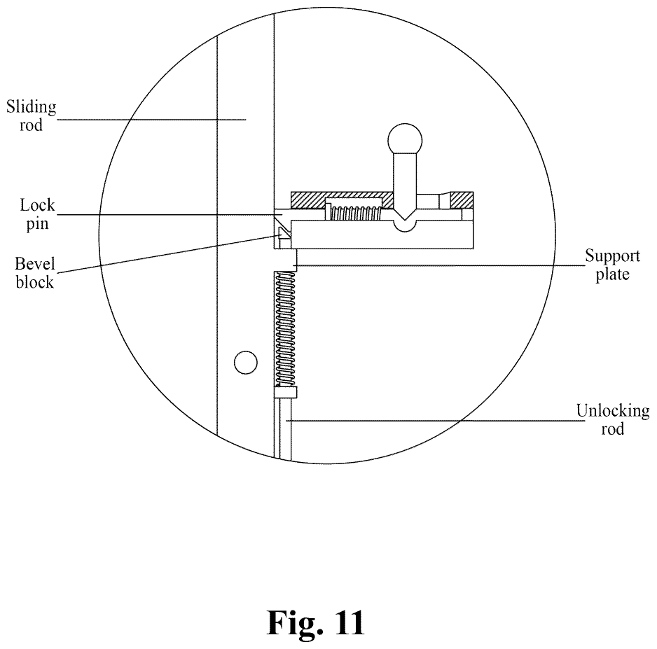

As shown in FIG. 1 to FIG. 11, a method for lifting and falling a stoplog gate for layered water intaking and ecological dispatching of a hydropower station, including the following steps:
S1. network establishment: an intelligent terminal of Internet of things, a 5G base station and a cloud platform are installed on on-site equipment to achieve man-machine communication between a background and the on-site equipment and ensure safe operation of an open-close gate; an intelligent terminal of Internet of Things for wireless communication transmission is added to be connected to an on-site gantry crane, the intelligent terminal is configured to collect various analog signals and switching signals on site in real time and to carry out data interaction with a cloud platform through a base station, thus replacing a commonly used wired transmission mode at present, and simplifying a remote communication method;
S2. a positioning and identification element is additionally added on each of a gantry mechanism and a trolley mechanism of the gantry crane, and orifices of a working gate slot of the stoplog gate and a gate storage slot are physically marked to ensure that the gantry crane can accurately travel to an orifice position of a designated gate slot, and then the gantry crane stops and a hydraulic grab beam is controlled to open and close the stoplog gat; for the main equipment, the accurate positioning of the gantry mechanism and the trolley mechanism are added;
S3. grab beam positioning: a height of the hydraulic grab beam is positioned through a height encoder on the gantry crane, and the height is compared with a preset parameter value of the system to ensure that the height of the hydraulic grab beam is controlled, when the hydraulic grab beam approaches the stoplog gate, the hydraulic grab beam is guided to enter a lifting lug of the stoplog gate through a positioning guide sleeve, and a pin shaft of a pin threading system of the hydraulic grab beam is enabled to pass through the lifting lug of the stoplog gate safely to ensure that the hydraulic grab beam is effectively connected to the stoplog gate; the automatic identification and determination of the gantry crane and the stoplog beam by the control system are achieved through accurate positioning of the stoplog gate by a hydraulic grab beam and automatic pin threading and threading in place, an automatic action-return function of a swing beam locking device as required, a function of automatically opening and closing a cover plate of a gate storage slot and a layered counting and identification function of a system for the stoplog gate, thus implementing remote operation of the stoplog gate, achieving automatic operation of layered water intaking and ecological dispatching, improving working efficiency, reducing long-term work of operating personnel at an orifice, reducing an operation risk, and improving the safety performance;
S4. automatic cover plate opening: cover plates on an orifice protective device of the gate storage slot are driven to open through two positioning cylinders on the hydraulic grab beam;
S5. layered dispatching: the stoplog gate is transferred by hoisting equipment to a position above an orifice of the stoplog gate, then the stoplog gate is released, a swing locking mechanism carries out automatic action and return during upward and downward movement of the gate storage slot to close or open the stoplog gate to achieve layered water intaking from a hydropower station;
S6. automatic cover plate closing: the hoisting equipment is configured to control and hoist the stoplog gate to a position above the gate storage slot, and the cover plates on the protective device are automatically closed when the stoplog gate is released into the gate storage slot.

By mainly taking remote operation as the technical goal, and taking the automatic gate taking, gate closing and gate opening logic of the gantry crane as the guide, and a set of rigorous operation logic for opening and closing the stoplog gate for layered water intaking and ecological dispatching is designed to achieve the on-site unmanned operation of the equipment. During the operation, remote operating staff are added to determine the key nodes in the operation process and visually monitor the equipment in the background, making the risks in the automatic gate opening and closing process of the remote operation controlled and ensure the safe operation of the equipment during the operation.

In a preferred scheme, the protective device includes claw-type mechanisms 102 connected to two ends of two cover plates 101, multiple counterweight arms 103 and folding arms 104 are connected to one side of each cover plate 101, an unlocking mechanism 105 is connected to the claw-type mechanism 102 and in fit with a locking mechanism 106, a contact roller 107 is fixedly connected to a ribbed slab of a side surface of the stoplog gate, and the cover plate 101 is hinged with an edge of the orifice of the gate storage slot. The locking mechanism 106 is located at one side of the gate storage slot and in fit and locking with the claw-type mechanism; the unlocking mechanism 105 is configured to unlock the locking mechanism 106 and pull the claw-type mechanism 102 to move upwards to close the cover plate 101. Alternatively, after the cover plate 101 is closed, a downward pressure of the folding arm 104 is applied, and the cover plate 101 is opened with the cooperation of the counterweight arm 103 and the folding arm 104. During installation, the locking mechanism 106 is fixed to an edge of the orifice of the gate storage slot.

In a preferred scheme, each cover plate 101 is a flat plate with a grid structure, and a circular through hole is formed in an open-close port of each of the two cover plates 101 to fit with a bump on the folding arm 104. The claw-type mechanism 102 includes piston rods hinged to both sides of an upper end of a sliding rod, the other ends of the piston rods are movably connected to the cover plates 101. The sliding rod is in sliding fit with a slide rail, and the slide rail is fixed to an inner wall of the gate storage slot. The locking mechanism 106 includes a lock pin which is in elastic and sliding fit with an inner side of a sleeve, the lock pin extends out of the sleeve and is in fit with a locking hole in the sliding rod, and an inclined plane is arranged at a front end of the lock pin to be in fit with the unlocking mechanism 105. The unlocking mechanism 105 includes a hook plate connected to a lower end of an unlocking rod, and a rolling shaft passing through the hook plate. A bevel block connected to an upper end of the unlocking rod is located on an upper part of a support plate on the side surface of the sliding rod, and the bevel block is in sliding contact with the inclined plane at the front end of the lock pin. A spring at a lower part of the support plate is sleeved outside the unlocking rod and abutted against a retaining ring on the support plate and the unlocking rod; and the hook plate is connected to a pin shaft at a lower end of the sliding rod, and the rolling shaft is in rolling contact with the slide rail. During use, the cover plate 101, when completely opened, forms a protection device together with the claw-type mechanism 102 and encloses the edge of the orifice of the gate storage slot to improve the safety performance.

In a preferred scheme, a gear is connected to an end head of the counterweight arm 103 and an end head of the folding arm 104, respectively, the gear is meshed with a gear at an end head of a slotted plate and located in a hinged seat of the cover plate 101, and the slotted plate is fixedly connected to the cover plate 101. One end, away from the gear, of the counterweight arm 103 is provided with a counterweight block, a bending structure is arranged at a middle part of the folding arm 104, and a bump is arranged on an upper side surface of one end of the folding arm 104. When two symmetrical folding arms 104 on the two cover plates 101 are in a horizontal state, the two bumps are located in the circular through holes in the cover plates 101 in a horizontal state. During use, in the process of closing the cover plate 101, the cover plate 101 is driven to overturn under the action of gear meshing through the cooperation of the counterweight arm 103 and the folding arm 104 and the slotted plate.

In a preferred scheme, the swing locking mechanism includes a rotating shaft in fit with upper ends of support arms 201 of a fixed seat, swing arms 202 are connected to shaft heads at two ends of the rotating shaft and inclined to one side. A locking beam 203 is located between the two support arms 201 and connected to the rotating shaft. A stress block 204 is located at a lower part of the swing arm 202 at one side of the support arm 201. The locking beam 203 is of a hollow structure, and a heavy hammer 205 is arranged in a compartment at a lower end thereof. The fixed seat of the swing locking mechanism is installed on a side surface of the orifice of the stoplog gate, and the swing arm 202 and the stress block 204 are close to the orifice of the stoplog gate. During use, the locking beam 203 is driven by the swing arm 202 to swing to enter or withdraw from a support hole of the stoplog gate to achieve action and return function. The safety of the stoplog gate during operation is improved, and the accurate dispatching and layered water intaking are facilitated.

In a preferred scheme, in S4, automatic cover plate opening includes the following steps:
S4-1: starting: the hydraulic grab beam is controlled by the hoisting equipment to move to an upper part of the orifice of the gate storage slot, and the positioning cylinders on the hydraulic grab beam move downwards;
S4-2: jacking: the positioning cylinders move downwards to abut against the bumps in the circular through holes in the two cover plates 101, and the folding arms 104 are driven to rotate downward around the hinged seats;
S4-3: cover plate opening: the cover plates 101 are driven to overturn upwards during downward rotation of the folding arms 104, the counterweight arms 103 are overturned downwards at the same time, and the two cover plates 101 are driven to form a certain opening therebetween under the action of dead weights of the counterweight arms 103 and the folding arms 104; and in this step, the piston rods extend synchronously;
S4-4: unlocking: the hydraulic grab beam is controlled by the hoisting equipment to ascend and move to an upper part of the stoplog gate, and the hydraulic grab beam is connected to the stoplog gate through a pin threading device on the hydraulic grab beam; the hydraulic grab beam is controlled by the hoisting equipment to drive the stoplog gate to move to a position between the two cover plates 101 and descend from an opening between the two cover plates 101; during the descending of the stoplog gate, the contact roller 107 on the side surface of the stoplog gate gradually makes contact with the hook plate of the unlocking plate 105, the bevel block at the upper end of the unlocking rod is driven to be in sliding contact with the inclined plane at the end head of the lock pin of the locking mechanism 106, making the lock pin gradually withdrawn from the locking hole in the side surface of the sliding rod; and
S4-5: protection forming: under a condition that the sliding rod is released, the counterweight arms 103 and the folding arms 104 further rotate downwards under the action of the dead weight, and the cover plates 101 are driven to be opened completely to jointly form protection together with the extended piston rods, which is enclosed around the orifice of the gate storage slot.

In a preferred scheme, in S5, a close gate and an open gate in layered dispatching and water intaking comprise accurate positioning of a gantry traveling mechanism and a trolley traveling mechanism of the gantry crane to complete accurate positioning of the stoplog gate by a hydraulic grab beam and automatic pin threading and withdrawing in place, an automatic action-return function of a swing beam locking device as required, and a function of automatically opening and closing a cover plate of a gate storage slot and a layered counting and identification function of a system for the stoplog gate, thus achieving automatic identification and determination of the gantry crane and the stoplog gate by the control system, and achieving automatic operation of layered water intaking and ecological dispatching.

Specifically, the closing process of the stoplog gate for layered water intaking of the hydropower station is as follows:
1. user login: entering an operating system only after entering authentication information and passing the verification;
2. operation information confirming: selecting a unit number*F of a stoplog gate to be operated through a touch screen, selecting the number of stoplog gates n to be operated, and confirming the operation;
3. starting and traveling of gantry mechanism of gantry crane: after receiving a confirming signal of “operating the unit number” sent by the background, starting a motor of the gantry mechanism of the gantry crane to travel to the stoplog gate of the unit number to be operated, and during the traveling of the gantry mechanism of the gantry crane, monitoring the traveling of the gantry crane by background operating staff behind to ensure the traveling safety of the gantry mechanism of the gantry crane;
4. stopping of gantry mechanism of gantry crane: when the system identifies a positioning signal of the unit, stopping the gantry crane, and after a stopping signal is sent out, reconfirming the position of the gantry crane by the background operating staff;
5. starting and traveling of trolley mechanism of gantry crane: after confirming a “stopping space” of the gantry mechanism of the gantry crane, starting a motor of the trolley mechanism of the gantry crane to travel to a working gate slot L1 of the stoplog gate to be operated according to a signal of “operating the number of stoplogs n” sent from the background, and during the traveling process of the trolley mechanism of the gantry crane, monitoring the traveling of the gantry crane by background operating staff behind to ensure the traveling safety of the trolley mechanism of the gantry crane;
6. stopping of trolley mechanism of gantry crane: systematic determination or manual determination:
a. systematic determination: stopping after the trolley mechanism of the gantry crane travels from the stopping space L to the stopping space L1 of the working gate slot of the stoplog gate;
b. manual determination: stopping after the background operation monitoring personnel confirm the stopping space of the trolley mechanism of the gantry crane;
7. descending of hydraulic grab beam: after receiving signal of “dropping grab beam” sent from the background, enabling the hydraulic grab beam to start descending, or automatically delaying the operation of this step;
8. positioning and stopping of grab beam: systematic determination or manual determination:
a. systematic determination: adopting a system image for comparison when the locking beam is in a locking position, enabling the stoplog gate to perform action when receiving an in-place signal, and stopping when displayed weight is less than or equal to the weight of the grab beam and the current height is a locking position VH7 of the stoplog gate, i.e., VH6+h;
b. manual determination: stopping after the background operation monitoring personnel confirm the stopping space of the grab beam;
9. pin threading and pump starting of grab beam: after receiving a signal of “pin threading of grab beam” sent from the background, performing pin threading and pump starting of the grab beam, or automatically delaying the operation of this step;
10. pump stopping when pin is threaded in place: after the system detects that the pin is threaded in place, stopping the pump, and after the pump stopping signal is sent out, confirming the in-place pin threading of the grab beam by the background operating staff;
11. gate lifting by grab beam and unlocking: after receiving a signal of “lifting the stoplog gate” sent from the background, starting to lift the stoplog gate by the grab beam, or automatically delaying the operation of this step;
where during the lifting, the swing locking beam rotates upwards with the stoplog gate under the condition of counterweight, and stops when the stoplog gate is lifted to the height of a stop and return position of the locking beam, i.e., VH8, so the locking beam breaks away from the constraint of the support hole in the stoplog gate and continues to swing and rotate to a vertical position under the driving of the counterweight of the locking beam body, thus achieving the automatic returning function of the swinging locking beam; and at this height position, a driving device installed on the stoplog gate is still below a contact arm, and thus will not affect the subsequent closing action of the stoplog gate;
12. stopping of grab beam: systematic determination or manual determination:
a. systematic determination: adopting system image for comparison when the locking beam is in an unlocking position, meanwhile, stopping when the current height is a height of the stop and return position of the locking beam, i.e., VH8;
b. manual determination: stopping after the background operation monitoring personnel confirm the position of the locking beam or the stoplog gate;
13. descending of the grab beam for gate closing: after receiving a signal of “descending for gate closing” sent from the background, enabling the grab beam to start descending for gate closing, or automatically delaying the operation of this step;
14. stopping of gate: systematic determination or manual determination;
a. systematic determination: adopting system image for comparison when the locking beam is in the unlocking position, stopping when displayed weight is less than or equal to the weight of the grab beam and the number of stoplog gates n in the working gate slot is equal to 1and the height is VH1, stopping when n is equal to 2 and the height is VH2, stopping when n is equal to 3 and the height is VH3, and stopping when n is equal to 4 and the height is VH4;
b, manual determination: stopping after the background operation monitoring personnel confirm the stopping space of the stoplog gate;
15. pin withdrawing and pump starting of grab beam: after receiving a signal of “pin withdrawing of grab beam” sent from the background, enabling the grab beam to start pump starting and pin withdrawing, or automatically delaying the operation of this step;
16. pump stopping when pin is withdrawn in place: stopping the pump when the system detects that the pin is withdrawn in place; manual determination: conforming that the pin of the grab beam is withdrawn in place;
17. lifting of grab beam: after receiving a signal of “lifting grab beam” sent from the background, enabling the grab beam to start lifting, or automatically delaying the operation of this step;
18. stopping of grab beam: systematic determination: stopping when a lifting height of grab beam is in place; manual determination: confirming when the grab beam is lifted in place;
a. systematic determination: when the number of remaining operations n0 is equal to 0,i.e., the number of layers to be operated n minus the number of layers that have been operated n1 is equal to 0, determining, by the system, that the gate closing operation is completed, and stopping when the hydraulic grab beam is lifted to an upper limit elevation VH12;
b. when the number of remaining operations n0 is greater than or equal to 1 is greater than or equal to 1, determining, by the system, that the gate closing operation is not completed, and stopping after lifting the hydraulic grab beam to a suspended position elevation VH10;
c. manual determination: stopping parking after the background operation monitoring personnel confirm the stopping space of the hydraulic grab beam;
19. starting and traveling of trolley of gantry crane: after the stopping of the grab beam is completed, starting the motor of the trolley traveling mechanism of the gantry crane to travel towards a direction determined by the system, monitoring, by background operating staff, the travel of the gantry crane during the traveling of the trolley mechanism of the gantry crane to ensure the traveling safety of the trolley mechanism of the gantry crane;
a. systematic determination: when the number of remaining operations n0 is equal to 0, determining, by the system, that the gate closing operation is completed, and driving the trolley mechanism to travel to a stopping space L0;
b. when the number of remaining operations n0 is greater than or equal to 1, determining, by the system, that the gate closing operation is not completed, and driving the trolley mechanism to travel to stopping spaces L2, L3 and L4 of the gate storage slot in turn;
c. manual determination: stopping after the background operation monitoring personnel confirm the stopping space of the trolley mechanism of the gantry crane;
20. stopping of trolley mechanism of gantry crane:
d. systematic determination: when the number of remaining operations n0 is equal to 0, determining, by the system, that the gate closing operation is completed, and stopping when the trolley mechanism travels to the stopping space L0, and triggering a signal of “returning gantry crane to base station”;
e. when the number of remaining operations n0 is greater than or equal to 1, determining, by the system, that the gate closing operation is not completed, and stopping when the trolley mechanism travels to stopping spaces L2, L3 and L4 of the gate storage slot in turn, and then skipping to step 23;
f. manual determination: stopping after the background operation monitoring personnel confirm the stopping space of the trolley mechanism of the gantry crane;
21. starting and traveling of gantry mechanism of gantry crane: after receiving a signal of “returning gantry crane to base station” sent from the background, starting the motor of the gantry traveling mechanism of the gantry crane to make the gantry traveling mechanism travel to a stopping base station of the gantry crane, or automatically delaying the operation of this step;
22. stopping of gantry crane: enabling the gantry crane to stop when the system identifies a positioning signal of the base station, and reconfirming, by the background operating staff, the position of the gantry crane;
23. descending of hydraulic grab beam and opening of cover plate of gate storage slot: after receiving a signal of “descending grab beam” sent from the background, enabling the hydraulic grab beam to start descending, or automatically delaying the operation of this step, where two positioning cylinders of the hydraulic grab beam are configured to trigger a cover plate opening mechanism at the same time, thus opening the cover plate of the gate storage slot under the dead weight state of the hydraulic grab beam;
24. positioning and stopping of grab beam: systematic determination or manual determination:
a. systematic determination: enabling the stoplog gate to perform action when receiving an in-place signal that the stoplog gate is in place, displayed weight is less than or equal to the weight of the grab beam, and stopping when the current height is equal to crest elevation VH6minus a length L of an operation rod of the cover plate, i.e., a storage position of the stoplog gate;
b. manual determination: stopping after the background operation monitoring personnel confirm the stopping space of the grab beam of the gantry crane;
25. pin threading and pump starting of grab beam: after receiving a signal of “pin threading of grab beam” sent from the background, performing pin threading and pump starting on the grab beam, or automatically delaying the operation of this step;
26. pump stopping when pin is threaded in place: stopping a pump when the system detects that the pin is threaded in place, and after sending out a pump stopping signal, reconfirming, by the background operating staff, that the pin of the grab beam is threaded in place;
27. lifting of stoplog gate by grab beam: after receiving a signal of “lifting stoplog gate” sent from the background, enabling the grab beam to start lifting the stoplog gate, or automatically delaying the operation of this step;
28. stopping of grab beam: systematic determination or manual determination:
c. systematic determination: when displayed weight is approximately equal to the weight of hydraulic grab beam plus the total weight+/−K of one layer of stoplog gate, setting K according to field debugging data, and stopping when the current height is VH11, i.e., a lifting elevation of the stoplog gate;
d. manual determination: stopping after the background operation monitoring personnel confirm the position of the stoplog gate;
29: starting and traveling of trolley mechanism of gantry crane: after the grab beam stops, starting the motor of the trolly traveling mechanism of the gantry crane to travel to the working gate slot L1 of the stoplog gate, monitoring, by the background operating staff, the traveling of the gantry crane during the traveling of the trolley mechanism of the gantry crane, thus ensuring the traveling safety of the trolley mechanism of the gantry crane;
30. stopping of trolley mechanism of gantry crane: systematic determination or manual determination:
a. systematic determination: stopping when the trolley mechanism of the gantry crane directly travels to the position of the working gate slot LI of the stoplog gate;
b. manual determination: stopping after the background operation monitoring personnel confirm the stopping space of the trolley mechanism of the gantry crane;
31. falling of grab beam for gate closing, and then executing steps 13-22 in turn.

Specifically, the opening process of the stoplog gate for layered water intaking of the hydropower station is as follows:
1. user login: entering an operating system only after entering authentication information and passing the verification;
2. operation information confirming: selecting a unit number*F of a stoplog gate to be operated through a touch screen, selecting the number of stoplog gates n to be operated, and confirming the operation;
3. starting and traveling of gantry mechanism of gantry crane: after receiving a confirming signal of “operating unit number” sent from the background, starting a motor of the gantry mechanism of the gantry crane to travel to the stoplog gate of the unit number to be operated, and during the traveling of the gantry mechanism of the gantry crane, monitoring the traveling of the gantry crane by background operating staff behind to ensure the traveling safety of the gantry mechanism of the gantry crane;
4. stopping of gantry mechanism of gantry crane: when the system identifies a positioning signal of the unit, stopping the gantry crane, and after a stopping signal is sent out, reconfirming the position of the gantry crane by the background operating staff;
5. starting and traveling of trolley mechanism of gantry crane: after confirming a “stopping space” of the gantry mechanism of the gantry crane, starting a motor of the trolley mechanism of the gantry crane to travel to a working gate slot L1 of the stoplog gate to be operated according to a signal of “operating the number of stoplogs n” sent from the background, and during the traveling process of the trolley mechanism of the gantry crane, monitoring the traveling of the gantry crane by background operating staff behind to ensure the traveling safety of the trolley mechanism of the gantry crane;
6. stopping of trolley mechanism of gantry crane: systematic determination or manual determination:
a. systematic determination: stopping after the trolley mechanism of the gantry crane travels from the stopping space L to the orifice of the working gate slot L1 of the stoplog gate;
b. manual determination: stopping after the background operation monitoring personnel confirm the stopping space of the trolley mechanism of the gantry crane;
7. descending of hydraulic grab beam: after receiving signal of “dropping grab beam” sent from the background, enabling the hydraulic grab beam to start descending, or automatically delaying the operation of this step;
8. positioning and stopping of grab beam: systematic determination or manual determination:
a. systematic determination: adopting a system image for comparison when the locking beam is in an unlocking position, enabling the stoplog gate to perform action when receiving an in-place signal, and stopping when displayed weight is less than or equal to the weight of the grab beam and the current height is VH1; stopping when n is equal 2 and the height is VH2; stopping when n is equal 3 and the height is VH3; and stopping when n is equal 4 and the height is VH4;
b. manual determination: stopping after the background operation monitoring personnel confirm the stopping space of the grab beam;
9. pin threading and pump starting of grab beam: after receiving a signal of “pin threading of grab beam” sent from the background, performing pin threading and pump starting of the grab beam, or automatically delaying the operation of this step;
10. pump stopping when pin is threaded in place: after the system detects that the pin is threaded in place, stopping the pump, and after the pump stopping signal is sent out, confirming the in-place pin threading of the grab beam by the background operating staff;
11. gate lifting by grab beam and unlocking: after receiving a signal of “lifting the stoplog gate” sent from the background, starting to lift the stoplog gate by the grab beam, or automatically delaying the operation of this step;
where during the lifting, a contact arm of the swing locking beam can avoid the upward movement of the stoplog gate, and stopping is carried out when the stoplog gate is lifted to a start and action position elevation of the locking beam, i.e., VH9; at this height, a driving device installed on the stoplog gate is located above the contact arm to make preparation in advance for triggering the contact arm when the stoplog gate descends;
12. stopping of grab beam: systematic determination or manual determination:
a. systematic determination: adopting system image for comparison when the number of remaining operations n0 is equal to 0, i.e., the number of layers to be operated n minus the number of layers that have been operated n1 is equal to 0, determining, by the system, that the gate closing operation is completed, and stopping when the hydraulic grab beam is lifted to the start and action position elevation VH9;
b. when the number of remaining operations n0 is greater than or equal to 1 is greater than or equal to 1, determining, by the system, that the gate closing operation is not completed, stopping after lifting the hydraulic grab beam to a lifting elevation VH11 of the stoplog gate, and then skipping to step 23;
c. manual determination: stopping after the background operation monitoring personnel confirm the position of the locking beam or the stoplog gate;
13. action and locking in the process of descending stoplog gate by grab beam: after receiving a signal of “descending for gate shutdown” sent from the background, enabling the grab beam to start descending the stoplog gate, or automatically delaying the operation of this step;
during descending, enabling the locking beam automatic action and return device to automatically perform action operation on the locking beam of the stoplog gate according to an actual situation on site, when the locking beam enters the support hole in the stoplog gate, enabling the driving device on the stoplog gate to be just separated from the contact arm of the locking beam by rolling, and subsequently rotating the locking beam to a horizontal position under the driving of gravity of the stoplog gate body, thus effectively supporting the stoplog gate;
14. stopping of gate: systematic determination or manual determination:
a. systematic determination: adopting system image for comparison when the locking beam is in a locking position, stopping when displayed weight is less than or equal to the weight of the grab beam and the height is VH7, i.e., a locking position of the stoplog gate;
b. manual determination: stopping after the background operation monitoring personnel confirm the stopping space of the stoplog gate;
15. pin withdrawing and pump starting of grab beam: after receiving a signal of “pin withdrawing of grab beam” sent from the background, enabling the grab beam to start pump starting and pin withdrawing, or automatically delaying the operation of this step;
16. pump stopping when pin is withdrawn in place: stopping the pump when the system detects that the pin is withdrawn in place; manual determination: conforming that the pin of the grab beam is withdrawn in place;
17. lifting of grab beam: after receiving a signal of “lifting grab beam” sent from the background, enabling the grab beam to start lifting, or automatically delaying the operation of this step;
18. stopping of grab beam: systematic determination: stopping when the grab beam is lifted to an upper limit elevation VH12; manual determination: confirming that the grab beam is lifted in place;
19. starting and traveling of trolley of gantry crane: after the stopping of the grab beam is completed, starting the motor of the trolley traveling mechanism of the gantry crane to travel towards a direction L determined by the system, monitoring, by the background operating staff, the travel of the gantry crane during the traveling of the trolley mechanism of the gantry crane to ensure the traveling safety of the trolley mechanism of the gantry crane;
20. stopping of trolley mechanism of gantry crane: systematic determination or manual determination:
a. systematic determination: stopping when the trolley mechanism travels to a stopping place L, and triggering a signal of “returning gantry crane to base station”;
b. manual determination: stopping after the background operation monitoring personnel confirm the stopping space of the trolley mechanism of the gantry crane;
21. starting and traveling of gantry crane: starting the motor of the gantry traveling mechanism of the gantry crane after receiving the signal of “returning gantry crane to base station” sent from the background, enabling the gantry travel mechanism of the gantry crane to travel to a parking base station of the gantry crane, or automatically delaying the operation of this step;
22. stopping of gantry crane: stopping the gantry crane when the system identifies a base station positioning signal, reconfirming, by the background operating staff, a position of the gantry crane;
23. starting and traveling of trolley mechanism of gantry crane: after the stopping of the grab beam is completed, starting the motor of the trolley traveling mechanism of the gantry crane, enabling the trolley traveling mechanism to travel towards the direction determined by the system, monitoring, by the background operating staff, the travel of the trolley crane during the traveling of the trolley mechanism of the gantry crane to ensure the traveling safety of the trolley mechanism of the gantry crane;
a. systematic determination: when the number of remaining operations n0 is equal to 3, determining, by the system, that the gate closing operation is not completed, and driving the trolley mechanism to travel to a position of the stopping place L4 of the gate storage slot;
b. when the number of remaining operations n0 is equal to 2, determining, by the system, that the gate closing operation is not completed, and driving the trolley mechanism to travel to a position of the stopping place L3 of the gate storage slot;
c. when the number of remaining operations n0 is equal to 1, determining, by the system, that the gate closing operation is not completed, and driving the trolley mechanism to travel to a position of the stopping place L2 of the gate storage slot;
d. manual determination: stopping after the background operation monitoring personnel confirm the stopping space of the trolley mechanism of the gantry crane;
24. sopping of trolley mechanism of gantry crane: systematic determination or manual determination:
a. systematic determination: stopping after the trolley mechanism of the gantry crane travels to a corresponding stopping place of the gate storage slot from the stopping place L1 of the working gate slot of the stoplog gate;
b. manual determination: stopping after the background operation monitoring personnel confirm the stopping space of the trolley mechanism of the gantry crane;
25. descending of grab beam for gate storage and closing of cover plate of gate storage slot: after the trolley stops, enabling the hydraulic grab beam to start descending for gate storage, or automatically delaying the operation of this step, where driving wheels installed on both sides of the stoplog gate body roll downwards to close the contact arm of a lifting pull rod of a cover plate auxiliary device during the downward movement; at an initial stage of contact, the contact arm will rotate downwards around a traveling support shaft to lift the unlocking rod upward to release the locking state of the locking device, and then continues to move downward to drive the pull rod to close the cover plate until the cover plate can be fully closed automatically, making the contact arm effectively separated from the driving wheel, thereby cutting off an external power source and ensuring the use safety of the closing auxiliary device; meanwhile, when the cover plate is in an opening position, auxiliary wheels at edges of both sides of the cover plate are in contact with the two side surfaces of the hydraulic grab beam and roll to ensure that the hydraulic grab beam moves upward without hindrance; and when the hydraulic grab beam is separated from the cover plate, the cover plate is fully closed under its dead weight, thus achieving the automatic closing function of the cover plate;
26. stopping of grab beam: systematic determination or manual determination
c. systematic determination: stopping when displayed weight is less than or equal to the weight of grab beam and the current height is equal to crest elevation VH6 minus a length L of an operation rod of the cover plate, i.e., a storage position of the stoplog gate;
d. manual determination: stopping after the background operation monitoring personnel confirm the stopping space of the grab beam;
27. pin withdrawing and pump starting of grab beam: after receiving a signal of “pin withdrawing of grab beam” sent from the background, enabling the grab beam to start pump starting and pin withdrawing, or automatically delaying the operation of this step;
28. pump stopping when pin is withdrawn in place: stopping the pump when the system detects that the pin is withdrawn in place; manual determination: conforming that the pin of the grab beam is withdrawn in place;
29. lifting of grab beam: enabling the grab beam to start lifting after receiving a signal of “lifting grab beam” sent from the background, or automatically delaying the operation of this step;
30. stopping of grab beam: systematic determination: stopping when the grab beam is lifted to a height of a suspended position elevation VH10; manual determination: confirming that the grab beam is lifted in place;
31. starting and traveling of trolley mechanism of gantry crane: after the grab beam stops, starting the motor of the trolly traveling mechanism of the gantry crane to travel to the working gate slot L1 of the stoplog gate, monitoring, by the background operating staff, the traveling of the gantry crane during the traveling of the trolley mechanism of the gantry crane, thus ensuring the traveling safety of the trolley mechanism of the gantry crane;
32. stopping of trolley mechanism of gantry crane: systematic determination or manual determination:
c. systematic determination: stopping when the trolley mechanism of the gantry crane directly travels to the position of the working gate slot LI of the stoplog gate;
d. manual determination: stopping after the background operation monitoring personnel confirm the stopping space of the trolley mechanism of the gantry crane;
33. falling of grab beam for gate closing, and then executing steps 8-22 in turn.

In a preferred scheme, in S6, automatic cover plate closing includes the following steps:
S6-1. hoisting and transferring: the hydraulic grab beam is lifted by the hoisting equipment and is connected to a pin threading hole in an upper side of a gate through a hydraulic pin threading device, and the gate is lifted and transferred by the hoisting equipment to the upper part of the orifice of the gate storage slot;

S6-2. descending and unlocking: the hydraulic grab beam is driving by the hoisting equipment to descend, the stoplog gate enters the orifice of the gate storage slot with the descending of the hydraulic grab beam, the contact roller 107 gradually makes contact with the swing arm 202 to drive the unlocking rods to move upward, and the bevel block at the front end of the unlocking rod is in sliding fit with the inclined plane at the end head of the lock pin, making the lock pin withdrawn from the locking hole in the sliding rod;
S6-3. initial closing: the stoplog gate continues to descend downwards to further push the swing arm 202 to make the rolling shaft on the hook plate gradually approach and make rolling contact with the slide rail, the unlocking rod is driven to pull the sliding rod to move downwards, where the sliding rod gradually drives the piston rod to fold and pull the cover plate 101 to close gradually during the downward movement, making two cover plates 101 form a certain opening, and in the step, in the process of gradually closing and overturning the cover plate 101, the folding arm and the counterweight arm rotate around the hinged seat, respectively;
S6-4. gate release: after the bottom of the stoplog gate is in contact with the bottom of the gate storage slot, the pin threading device of the hydraulic grab beam withdraws from the pin threading hole in the upper side of the gate, and the hydraulic grab beam is lifted by the hoisting equipment to ascend gradually; and
S6-5: complete closing: after the hydraulic grab beam completely withdraws from the upper parts of the two cover plates 101, the cover plates 101 are completely closed by means of own gravity and the dead weights of the counterweight arms 103 and the folding arms 104, meanwhile; in this time, the end head of the lower end of the sliding rod to abut against with an end plate at a lower end of the slide rail for limiting, retracting the piston rods of the claw-type mechanisms 102 to support both ends of the cover plate 101.

In a preferred scheme, the action of the swing locking mechanism includes the following steps:
the hydraulic grab beam controls the stoplog gate to move downwards, where in the process that the stoplog gate falls into gate slot of the stoplog gate, the contact roller 107 gradually makes rolling contact with the upper side surface of the swing arm 202 to drive the swing arm 202 to drive the rotating shaft to rotate, and the rotating shaft drives the locking beam 203 to deflect towards an inner side of a support hole in the stoplog gate, making an end head at an upper end of the locking beam 203 enter the support hole in the stoplog gate; downward movement of the locking beam 203 is limited by the stress block 204, thus preventing the stoplog gate from moving downwards and making the stoplog gate in a locking position, and the contact roller 107 is located at a lower part of the swing arm 202 at the moment.

In a preferred scheme, the return of the swing locking mechanism includes the following steps:
the hydraulic grab beam controls the stoplog gate to move upwards, the locking beam 203 deflects under the action of the heavy hammer 205 to gradually withdraw from the support hole of the stoplog gate in a vertical state; and
if the locking beam 203 is withdrawn from the support hole in the stoplog gate during upward movement of the stoplog gate, and the contact roller 107 is still at the lower part of the swing arm 202, it is regarded that the stoplog gate is in an unconstrained state, the stoplog gate is continuously released to move downwards, and the hydraulic grab beam controls a falling height of the stoplog gate.

The above embodiment is only the preferred technical solution of the present disclosure, and should not be regarded as the limitation of the present disclosure. The embodiments in the present disclosure and the features in the embodiments can be arbitrarily combined with each other without conflict. The scope of protection of the present disclosure shall be the technical solution described in the claims, including the equivalent alternatives of technical features in the technical solution described in the claims. That is, equivalent substitution improvements within such a scope are also within the scope of protection of the present disclosure.

What is claimed is:

1. A method for lifting and falling a stoplog gate for layered water intaking and ecological dispatching of a hydropower station, comprising the following steps:
S1: network establishment: installing an intelligent terminal of Internet of things, a 5G base station and a cloud platform on on-site equipment to achieve man-machine communication between a background and the on-site equipment and ensure safe operation of an open-close gate;
S2: gantry crane positioning: additionally adding a positioning and identification element on each of a gantry mechanism and a trolley mechanism of the gantry crane, and physically marking orifices of a working gate slot of the stoplog gate and a gate storage slot to ensure that the gantry crane is able to accurately travel to an orifice position of a designated gate slot, and then stopping and controlling a hydraulic grab beam to open and close the stoplog gate;
S3: grab beam positioning: positioning a height of the hydraulic grab beam through a height encoder on the gantry crane, and comparing the height with a preset parameter value of the system to ensure that the height of the hydraulic grab beam is controlled, when the hydraulic grab beam approaches the stoplog gate, guiding the hydraulic grab beam to enter a lifting lug of the stoplog gate through a positioning guide sleeve, and enabling a pin shaft of a pin threading system of the hydraulic grab beam to pass through the lifting lug of the stoplog gate safely to ensure that the hydraulic grab beam is effectively connected to the stoplog gate;
S4: automatic cover plate opening: driving cover plates on an orifice protection device of the gate storage slot to open through two positioning cylinders on the hydraulic grab beam;
S5: layered dispatching: transferring, by hoisting equipment, the stoplog gate to a position above a stoplog gate orifice, and releasing the stoplog gate, wherein a swing locking mechanism carries out automatic action and return during upward and downward movement of the gate storage slot to close or open the stoplog gate to achieve layered water intaking from a hydropower station; and
S6: automatic cover plate closing: controlling and hoisting, by the hoisting equipment, the stoplog gate to a position above the gate storage slot, and automatically closing the cover plates on the protection device when the stoplog gate is released into the gate storage slot.

2. The method for lifting and falling a stoplog gate for layered water intaking and ecological dispatching of a hydropower station according to claim 1, wherein the protection device comprises claw-type mechanisms (102) connected to two ends of two cover plates (101), a plurality of counterweight arms (103) and folding arms (104) are connected to one side of each cover plate (101), an unlocking mechanism (105) is connected to the claw-type mechanism (102) and in fit with a locking mechanism (106), a contact roller (107) is fixedly connected to a ribbed slab of a side surface of the stoplog gate, and the cover plate (101) is hinged with an edge of the gate storage slot; the locking mechanism (106) is located at one side of the gate storage slot and in fit and locking with the claw-type mechanism; the unlocking mechanism (105) is configured to unlock the locking mechanism (106) and pull the claw-type mechanism (102) to move upwards to close the cover plate (101); or after the cover plate (101) is closed, a downward pressure of the folding arm (104) is applied, and the cover plate (101) is opened with the cooperation of the counterweight arm (103) and the folding arm (104).

3. The method for lifting and falling a stoplog gate for layered water intaking and ecological dispatching of a hydropower station according to claim 2, wherein each cover plate (101) is a flat plate with a grid structure, and a circular through hole is formed in an open-close port of each of the two cover plates (101) to fit with a bump on the folding arm (104); the claw-type mechanism (102) comprises piston rods hinged to both sides of an upper end of a sliding rod, the other ends of the piston rods are movably connected to the cover plates (101); the sliding rod is in sliding fit with a slide rail, and the slide rail is fixed to an inner wall of the gate storage slot; the locking mechanism (106) comprises a lock pin which is in elastic and sliding fit with an inner side of a sleeve, the lock pin extends out of the sleeve and is in fit with a locking hole in the sliding rod, and an inclined plane is arranged at a front end of the lock pin to be in fit with the unlocking mechanism (105); the unlocking mechanism (105) comprises a hook plate connected to a lower end of an unlocking rod, and a rolling shaft passing through the hook plate;
a bevel block connected to an upper end of the unlocking rod is located on an upper part of a support plate on the side surface of the sliding rod, and the bevel block is in sliding contact with the inclined plane at the front end of the lock pin; a spring at a lower part of the support plate is sleeved outside the unlocking rod and abutted against a retaining ring on the support plate and the unlocking rod; and the hook plate is connected to a pin shaft at a lower end of the sliding rod, and the rolling shaft is in rolling contact with the slide rail.

4. The method for lifting and falling a stoplog gate for layered water intaking and ecological dispatching of a hydropower station according to claim 2, wherein a gear is connected to an end head of the counterweight arm (103) and an end head of the folding arm (104), respectively, the gear is meshed with a gear at an end head of a slotted plate and located in a hinged seat of the cover plate (101), and the slotted plate is fixedly connected to the cover plate (101); one end, away from the gear, of the counterweight arm (103) is provided with a counterweight block, a bending structure is arranged at a middle part of the folding arm (104), and a bump is arranged on an upper side surface of one end of the folding arm (104); and when two symmetrical folding arms (104) on the two cover plates (101) are in a horizontal state, the two bumps are located in the circular through holes in the cover plates (101) in a horizontal state.

5. The method for lifting and falling a stoplog gate for layered water intaking and ecological dispatching of a hydropower station according to claim 1, wherein the swing locking mechanism comprises a rotating shaft in fit with upper ends of support arms (201) of a fixed seat, swing arms (202) are connected to shaft heads at two ends of the rotating shaft and inclined to one side; a locking beam (203) is located between the two support arms (201) and connected to the rotating shaft; a stress block (204) is located at a lower part of the swing arm (202) at one side of the support arm (201); the locking beam (203) is of a hollow structure, and a heavy hammer (205) is arranged in a compartment at a lower end thereof; the fixed seat of the swing locking mechanism is installed on a side surface of the stoplog gate orifice, and the swing arm (202) and the stress block (204) are close to the stoplog gate orifice.

6. The method for lifting and falling a stoplog gate for layered water intaking and ecological dispatching of a hydropower station according to claim 1, wherein in S4, automatic cover plate opening comprises the following steps:
S4-1: starting: controlling, by the hoisting equipment, the hydraulic grab beam to move to an upper part of the orifice of the gate storage slot, and making the positioning cylinders on the hydraulic grab beam move downwards;
S4-2: jacking: enabling the positioning cylinders to move downwards to abut against the bumps in the circular through holes in the two cover plates (101), and driving the folding arms (104) to rotate downward around the hinged seats;
S4-3: cover plate opening: driving the cover plates (101) to overturn upwards during downward rotation of the folding arms (104), and overturning the counterweight arms (103) downwards at the same time, and driving the two cover plates (101) to form a certain opening therebetween under the action of dead weights of the counterweight arms (103) and the folding arms (104), wherein the piston rods extend synchronously in the step;
S4-4: unlocking: controlling, by the hoisting equipment, the hydraulic grab beam to ascend and move to an upper part of the stoplog gate, connecting a pin threading device on the hydraulic grab beam to the stoplog gate; controlling, by the hoisting equipment, the hydraulic grab beam to drive the stoplog gate to move to a position between the two cover plates (101) and descend from an opening between the two cover plates (101), wherein during the descending of the stoplog gate, the contact roller (107) on the side surface of the stoplog gate gradually makes contact with the hook plate of the unlocking plate (105), the bevel block at the upper end of the unlocking rod is driven to be in sliding contact with the inclined plane at the end head of the lock pin of the locking mechanism (106), making the lock pin gradually withdrawn from the locking hole in the side surface of the sliding rod; and
S4-5: protection forming: under a condition that the sliding rod is released, enabling the counterweight arms (103) and the folding arms (104) to further rotate downwards under the action of the dead weight, wherein the cover plates (101) are driven to be opened completely to jointly form protection together with the extended piston rods, which is enclosed around the orifice of the gate storage slot.

7. The method for lifting and falling a stoplog gate for layered water intaking and ecological dispatching of a hydropower station according to claim 1, wherein in S5, a close gate and an open gate in layered dispatching and water intaking comprise accurate positioning of a gantry traveling mechanism and a trolley traveling mechanism of the gantry crane to complete accurate positioning of the stoplog gate by a hydraulic grab beam and automatic pin threading and withdrawing in place, an automatic action-return function of a swing beam locking device as required, and a function of automatically opening and closing a cover plate of a gate storage slot and a layered counting and identification function of a system for the stoplog gate, thus achieving automatic identification and determination of the gantry crane and the stoplog gate by the control system, and achieving automatic operation of layered water intaking and ecological dispatching.

8. The method for lifting and falling a stoplog gate for layered water intaking and ecological dispatching of a hydropower station according to claim 1, wherein in S6, automatic cover plate closing comprises the following steps:
S6-1: hoisting and transferring: hoisting, by the hoisting equipment, the hydraulic grab beam, connecting the hydraulic grab beam to a pin threading hole in an upper side of a gate through a hydraulic pin threading device, and then lifting and transferring, by the hoisting equipment, the gate to the upper part of the orifice of the gate storage slot;
S6-2: descending and unlocking: driving, by the hoisting equipment, the hydraulic grab beam to descend, wherein the stoplog gate enters the orifice of the gate storage slot with the descending of the hydraulic grab beam, the contact roller (107) gradually makes contact with the swing arm (202) to drive the unlocking rods to move upward, and the bevel block at the front end of the unlocking rod is in sliding fit with the inclined plane at the end head of the lock pin, making the lock pin withdrawn from the locking hole in the sliding rod;
S6-3: initial closing: enabling the stoplog gate to continue to descend downwards, further pushing the swing arm (202) to make the rolling shaft on the hook plate gradually approach and make rolling contact with the slide rail, driving the unlocking rod to pull the sliding rod to move downwards, wherein the sliding rod gradually drives the piston rod to fold and pull the cover plate (101) to close gradually during the downward movement, making two cover plates (101) form a certain opening, and in the step, in the process of gradually closing and overturning the cover plate (101), the folding arm and the counterweight arm rotate around the hinged seat, respectively;
S6-4: gate release: after the bottom of the stoplog gate is in contact with the bottom of the gate storage slot, enabling the pin threading device of the hydraulic grab beam to withdraw from the pin threading hole in the upper side of the gate, and lifting, by the hoisting equipment, the hydraulic grab beam to ascend gradually; and
S6-5: complete closing: after the hydraulic grab beam completely withdraws from the upper parts of the two cover plates (101), enabling the cover plates (101) to be completely closed by means of own gravity and the dead weights of the counterweight arms (103) and the folding arms (104), meanwhile, enabling the end head of the lower end of the sliding rod to abut against with an end plate at a lower end of the slide rail for limiting, retracting the piston rods of the claw-type mechanisms (102) to support both ends of the cover plate (101).

9. The method for lifting and falling a stoplog gate for layered water intaking and ecological dispatching of a hydropower station according to claim 7, wherein the action of the swing locking mechanism comprises the following steps:
controlling, by the hydraulic grab beam, the stoplog gate to move downwards, wherein in the process that the stoplog gate falls into a gate slot of the stoplog gate, the contact roller (107) gradually makes rolling contact with the upper side surface of the swing arm (202) to drive the swing arm (202) to drive the rotating shaft to rotate, and the rotating shaft drives the locking beam (203) to deflect towards an inner side of a support hole in the stoplog gate, making an end head at an upper end of the locking beam (203) enter the support hole in the stoplog gate; limiting downward movement of the locking beam (203) by the stress block (204), thus preventing the stoplog gate from moving downwards and making the stoplog gate in a locking position, wherein the contact roller (107) is located at a lower part of the swing arm (202) at the moment.

10. The method for lifting and falling a stoplog gate for layered water intaking and ecological dispatching of a hydropower station according to claim 7, wherein the return of the swing locking mechanism comprises the following steps:
controlling, by the hydraulic grab beam, the stoplog gate to move upwards, wherein the locking beam (203) deflects under the action of the heavy hammer (205) to gradually withdraw from the support hole in the stoplog gate in a vertical state; and
if the locking beam (203) is withdrawn from the support hole in the stoplog gate during upward movement of the stoplog gate, and the contact roller (107) is still at the lower part of the swing arm (202), regarding that the stoplog gate is in an unconstrained state, continuing to release the stoplog gate to move downwards, and controlling, by the hydraulic grab beam, a descending height of the stoplog gate.
